(19) United States
(12) Patent Application Publication
(10) Pub. No.: US 2014/0337971 A1
(43) Pub. Date: Nov. 13, 2014

(54) COMPUTER INFRASTRUCTURE SECURITY MANAGEMENT

(71) Applicants: Marco Casassa Mont, Bristol (GB); Yolanta Beresnevichiene, Bristol (GB); Shane Sullivan, Bristol (GB); Richard Brown, Bristol (GB)

(72) Inventors: Marco Casassa Mont, Bristol (GB); Yolanta Beresnevichiene, Bristol (GB); Shane Sullivan, Bristol (GB); Richard Brown, Bristol (GB)

(21) Appl. No.: 14/371,610

(22) PCT Filed: Feb. 22, 2012
(86) PCT No.: PCT/US2012/026040

§ 371 Date: Jul. 10, 2014

(51) Int. Cl. G06F 21/50

(52) U.S. Cl. CPC G06F 21/50
USPC 726/22

(57) ABSTRACT

A mapping system is provided that makes use of security data collected from various data sources. Following appropriate pre-processing, the mapping system analyses the security data to provide estimated values for parameters in a security model, the security model in turn being based on one or more mathematical representations.

### BACKGROUND

Ensuring the security of a computing or information technology (IT) infrastructure, is important for an organisation. There are many threats and vulnerabilities. These may originate from internal and external sources on technical and administrative levels. Typically an organisation will have suitable policies and controls to identify and mitigate threats and vulnerabilities. For example, they may employ computer security professionals and/or install security systems to monitor the computing infrastructure and provide security alerts. These latter systems are often referred to as security information and event management (SEM) systems.

Any security solution needs to be suitable for the organisation. However, all organisations vary. Amongst others, organisations may vary in size; in hardware infrastructure; in geographical distribution; and in operational culture. To take account of these variations, expensive and time-consuming solutions are often required. Due consideration also needs to be given to the ever-changing nature of security threats: new technologies are developed, clyptographic systems are deciphered and most infrastructures are continually developing. For example, the explosive growth of mobile devices presents new challenges that may not have been anticipated when implementing legacy security systems.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein;

FIG. 1 is a schematic block diagram of a method for analysing security risks relating to a computing infrastructure;

FIG. 2 is a schematic diagram showing at least a portion of an exemplary security model for use in identity and access management;

FIG. 3 is a schematic, block diagram showing at least a portion of an exemplary security model illustrating vulnerability and patch management processes;

FIG. 4A is a schematic diagram showing an exemplary system for analysing a computing infrastructure according to an example;

FIG. 4B is a flow diagram showing an exemplary method for analysing a computing infrastructure according to an example;

FIG. 5 is a schematic diagram showing exemplary components that may be used to implement at least a portion of the exemplary system of FIG. 4A;

FIGS. 6A to 6D illustrate exemplary security data that may be recorded by a security monitoring system;

FIG. 7 is an illustrative screen shot of a first interface for configuring data sources according to an exemplary implementation;

FIG. 8 is an illustrative screen shot of a second interface for configuring the pre-processing of data according to an exemplary implementation;

FIG. 9 is an illustrative screen shot of a third interface displaying the results of data processing according to an exemplary implementation; and

FIG. 10 is a chart showing an exemplary estimated take-up curve.

### DETAILED DESCRIPTION

Certain examples described herein provide a system that analyses low-level raw data such as that produced by monitoring and/or event information systems operating on a computing infrastructure. This raw data is processed into a form that can be analysed, e.g. statistically and/or numerically. Following analysis, more meaningful data is derived from the original raw data that can be directly used in security risk analysis systems, for example systems that use modelling and simulations. The transformed data, and the result of any further modelling and simulation, may be used to inform policy decisions relating to the modification, upgrade or replacement of security systems for the computing infrastructure. Modelling and simulation may include any of predictions, speculative analysis and scenario planning.

As used in the following description, a computing infrastructure may comprise one or more computing devices coupled to one or more heterogeneous networks. The computing devices may comprise, amongst others, workstations, laptops, mobile and tablet devices, routers, servers, networked storage, sensors, networked appliances, access points, and gateways. The networks may use a variety of wired or wireless access mechanisms including telecommunications technologies. The networks may be arranged in local, metropolitan and/or global configurations with multiple sites and specifications. They may comprise a mix of private and public networks.

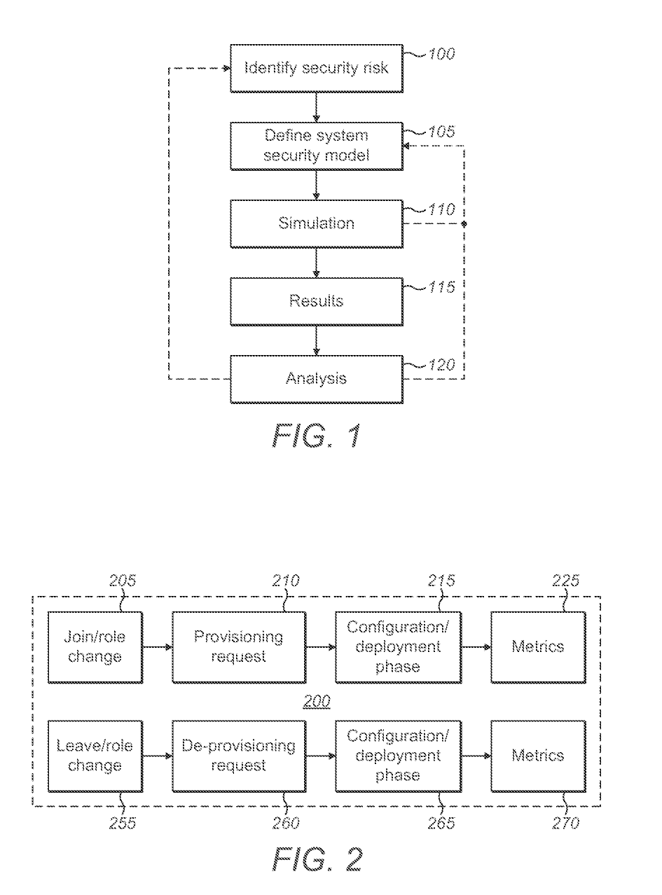

FIG. 1 is a schematic block diagram of a method for analysing security risks relating to a computing infrastructure. This method may be used or adapted to incorporate examples described later herein. In block 100 a potential security risk is identified. This can include a characterisation of a problem, such as a characterisation provided by a decision-maker in an organisation such as a Chief Information Security Officer (CISO). For example, a problem may comprise a belief that the number of illegal log-ins is higher than it should be. This problem may be reported by members of a security team, users or system administrators. Alternatively, an organisation may be considering an investment in specific solutions to better manage access privileges of its users. Associated with this investment, a CISO has a range of choices for the nature of the resulting system configuration, including security controls and specific solutions, and a range of preferences among the security outcomes. In this case, the identified security risk could be the risks associated with various implementations of access controls (or the lack of an implementation).

In block 105, a system security model is defined. This involves modelling the behaviour of processes relating to the computing infrastructure. A mathematical representation of a process based on the probabilities of discrete events occurring in relation to the process may be used. In this stage any of architectural, policy, business process, and behavioural constraints, amongst others, which are inherent in the security problem are captured and formalized. For example, in a security model representing possible electronic attacks on the computing infrastructure, threat environment characteristics such as potential attacker behaviour, threat vectors and probabilities and other externalities that may influence an internal business process or human behaviour in the organisation are identified and captured as events. In other approaches, reports, rather than models may be issued based on a review of the computing infrastructure, typically by auditors or consultants.

In block 110, the security model of block 105 is used in a simulation to generate results 115 that can be analysed at block 120 for a deeper understanding of a security risk or proposed implementation. In a generic case, a security model comprises a mathematical representation that is defined by parameters and variables. The mathematical representation may be probabilistic, e.g. a process may be represented using probabilities or probability distributions. For example, in a basic case, if the mathematical representation uses linear regression, i.e. comprises a linear function of the form y=mx+c, the parameters of the representation are the multiplier ‘m’ and the constant ‘c’ and the variables are ‘y’ and ‘x’, the ‘y’ variable being the result of the function. A simulation may be performed by varying a variable range (e.g. the range of ‘x’ values) or one or more parameters. In another example, user requests to a server may be modelled using queuing theory (e.g. using Poisson processes or exponential distributions); simulations may be run to determine the effect on user waiting time of adding more servers. Certain parameters may be fixed by the computing infrastructure and its environment and others may be variable depending on a proposed implementation. A simulation may explore the value space for a variable parameter. That is to say, using a security model, behaviour of the computing infrastructure is simulated by exploring one or more search spaces in order to provide results 115 which can be representative of multiple output configurations for the computing infrastructure. A simulation may comprise Monte Caro methods and/or may provide statistically verifiable results. If the result of the simulations at block 110 does not accurately reflect the actual behaviour of the processes then the security model may be refined, i.e. the method may return to block 105 as shown by the dotted line.

At block 120, the outcome of the simulation is analysed. For example, the requirements of existing or proposed security policies for the computing infrastructure may be compared with the results 115. Examples of policy requirements may comprise a requirement that all new patches must be applied within 30 days, a requirement that all user requests must be acknowledged within one second or less or a requirement that user data relating to ex-employees must be deleted or archived within 10 days. These requirements may be measured using security metrics. in this case, “patching” refers to the installation of an update to a piece of software such as an operating system or application. If there are outcomes within the results that match existing decisions, policies or configurations for the computing infrastructure, for example through simulation it may be determined that three server devices are required to meet an acknowledgement time of one second or less, then actions based on the analysis 120 may be taken, for example three server devices may be purchased. If there are no simulation outcomes that match existing policies, for example it may be determined that an acknowledgement time of one second or less is impossible to achieve, then the identification of the security risks or the security model may need to be refined, as represented by the dotted lines to blocks 100 and 105. Additionally block 105 may need to be revisited as new problems arise.

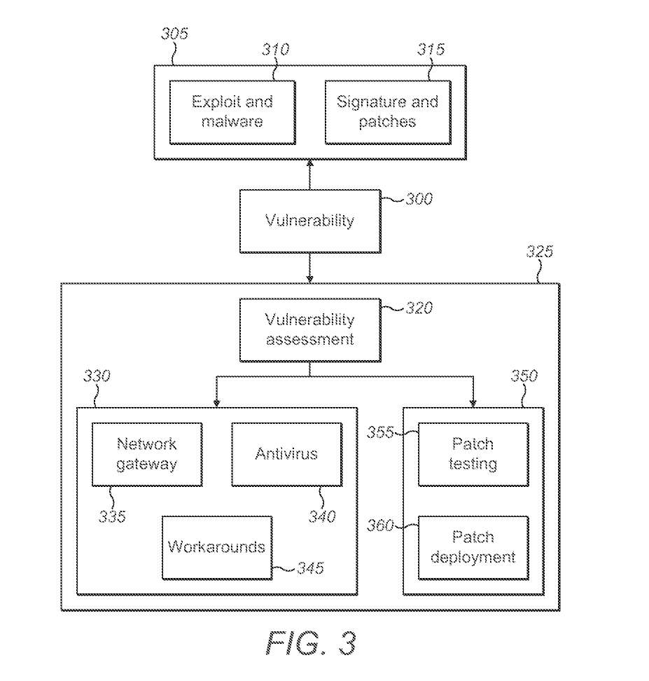

FIG. 2 is a schematic block diagram of at least a portion of a security model 200 for typical identity and access management provisioning and de-provisioning processes within an organisation. Identity and access management security models may be used for events that modify a user profile, a user profile being a data record associated with a user account on the computing infrastructure. FIG. 2 shows two discrete events that may modify a user profile: in a first join/change role event 205 a user may on an organisation or change their role, thus needing to be added as a user of a computing infrastructure or requiring access privileges to be upgraded, downgraded or created; and in a second leave/role change event 255 a user may leave an organisation or change their role, thus requiring a user profile to be archived or deleted.

Following the first join/change role event 205, a provisioning request 210 is generated for the provision of access to one or more applications and/or computing devices forming part of the computing infrastructure. There is then a configuration/deployment phase 215 in which the access rights are determined, verified and deployed for the user. For example, a computing department within the organisation can generate the desired security or access credentials for the user in response to the request 210, and communicate those credentials to the user, or someone else in the user's hierarchy (such as a manager for example). Once the security model is defined a set of metrics 225 can be used to monitor various phases of the process. For example, the time taken to process a request 210 can be monitored, as well as whether or not the configuration and/or deployment phase 215 was successful. In particular, the following sub-processes can be modelled and monitored: a loss of a provisioning request; a waiting time to approval of a request; a loss of a deployment request; a waiting time for deployment; and misconfiguration of a new user, e.g. unsuccessful deployment.

Similarly, following a second leave/role change event 255, if access privileges should be downgraded or revoked, a de-provisioning request 260 can be used to fulfil the changes. Accordingly, a configuration/deployment phase 265 determines the access rights which should be changed as a result of the request 260, and executes the changes by, for example, revoking a security credential for the user or downgrading/changing a security credential so that access privileges for the user are less privileged than they were, or only permit access to limited or different systems than before the change was deployed. A set of metrics 270 can be used to monitor various sub-processes or phases associated with the request 260. For example, the time taken to process the request can be monitored, as well as whether or not the configuration and/or deployment phase 113 was successful.

A security model may be used in two contexts: in a first context the security model serves as a guide for audit measurements involving the computing infrastructure; in a second context the security model serves as a framework for simulation using the measurements. For example, in the first context existing software operating on the computing infrastructure may be adapted so that a measurement is made relating to each of a number of sub-processes or phases, i.e. relating to metrics 225 or 270. Using measurements for multiple events, appropriate probability distributions that model the measurements are determined for simulation. For example, the loss of a provisioning request may be modelled as a Bernoulli process using a binomial probability distribution. The parameters of the binomial probability distribution may be derived from the metrics 225. In the second context referred to above, a simulation of a provisioning request 210 may comprise a random sampling of the modelled Bernoulli process. Hence, security models can be used for at least: one, conveying, in a scientific manner, current security, risk and threat circumstances by using suitable metrics calculated using the model; and two, speculative (i.e. so-called “what-if”) analysis and scenario planning, for example, by exploring variants of processes and/or exploring different model assumptions. in the second case, simulations convey results and predictions via security metrics, the results and predictions being dependent on input parameters for the security model.

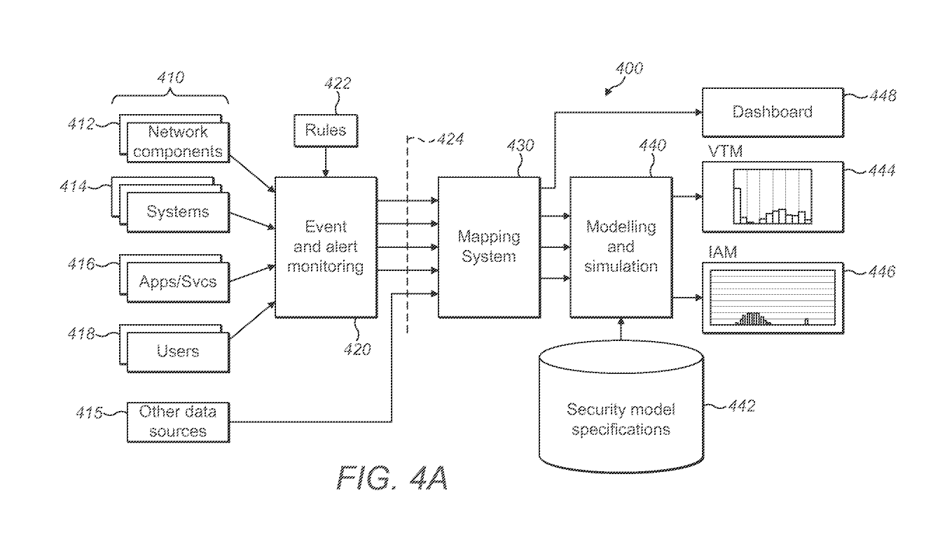

FIG. 3 is a schematic block diagram of at least a portion of a security model for vulnerability and patch management processes according to an example. A vulnerability 300 such as a security risk that is to say, a weakness within the computing infrastructure which allows an attacker to reduce the infrastructure's information integrity can be exploited or fixed. For example, an external entity 305 (to the computing infrastructure) can use the vulnerability to exploit the infrastructure in which it is present using malware 310 for example. A signature and patch(es) for the vulnerability 315 can be generated in response to the detection of the vulnerability. This can be in response to knowledge of an exploit and malware, or can be a proactive measure to prevent an exploit occurring. Internal processes 325 (to an organisation, i.e. relating to the computing infrastructure) proceed by assessing the vulnerability 300 in block 320 to determine the nature and potential impact of the vulnerability. As a result of the assessment 320, mitigations 330 or patch management 350 or both can be deployed in a system in order to counteract the vulnerability 300. Mitigations 330 can include antivirus deployment 340, putting workarounds 345 in place, installing a network gateway 335 to monitor and interpose on network connections and traffic, or some combination. Other mitigations are possible. Patch management 350 can include testing of a patch 355 in order to determine its effectiveness at counteracting the vulnerability, as well as determining an effect on the computing infrastructure, such as disruption to services and systems as a result of downtime for example. Following testing 355, patch deployment 360 can proceed, in which a patch or multiple patches are applied to systems of the computing infrastructure in which the vulnerability was discovered, or which could be affected. For example, patches can be applied to servers hosting an operating system which is used to execute tools used in an organisation. Patches could also typically be deployed on individual user workstations for example.

As demonstrated by the above examples, a security model may include one or more mathematical representations of a set of internal and external processes or components to represent aspects of the computing infrastructure, its environment and a security risk under consideration. External components may correspond to a threat environment and can include the rate of discovery of vulnerabilities, a speed to develop exploits, a speed to develop patches and signatures, attacker behaviour etc. Internal components can include specific tasks undertaken in security operations, a speed with which these tasks are undertaken, internal threats, human behaviour, human-system interactions, information and process flows, decision points, errors and process failures and specific security solutions and mechanisms and their properties.

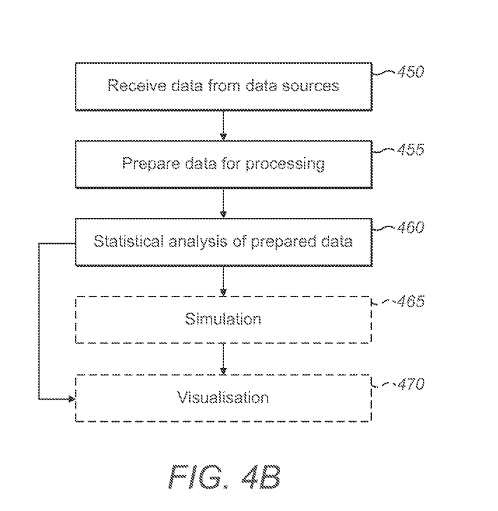

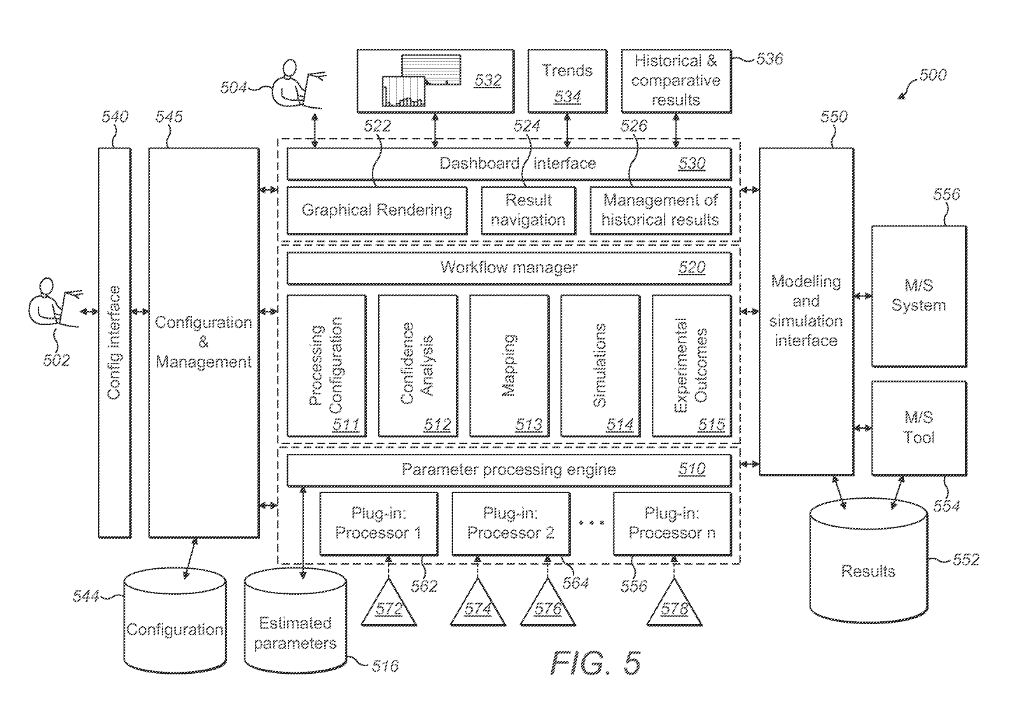

The examples described below allow parameter values for security models to be determined based on collected data. FIG. 4A shows an exemplary system 400 for managing a computing infrastructure according to an example. The system 400 builds upon the modelling and measurement activities described above. The system 400 has a first set of data sources 410. The first set of data sources comprise any device that provides data relating to the operation of the computing infrastructure. In the example of FIG. 4A this includes any of network components 412, computing systems 414, applications and/or server-provided services 416 and any device actuated by a user 418. in the example of FIG. 4A, the first set of data sources 410 feed data to an event and alert monitoring system 420. This may be a SEM system that takes real-time event data from data sources 410 and applies one or more rules 422 to generate one or more real-time alerts. As an example, a first event may comprise the packet data throughput of a router exceeding a predetermined threshold; a second event may comprise a count of requests to a blacklisted Internet Protocol (IP) address exceeding a predetermined threshold; and a third event may be a user not being logged in to a computing device. A rule 422 may be constructed to process the three events and output an alert indicating a possible compromise in the integrity of an internal network. The alert may be displayed to security personnel who can investigate any breach of the computing infrastructure by malicious software.

The example shown in FIG. 4A differs from other systems in the use of a mapping system 430. The mapping system 430 receives data across interface 424 from at least the event and alert monitoring system 420. This data may comprise event and/or alert data, for example raw data that is passed through the event and alert monitoring system 420 or derived alerts. In other examples, event and alert monitoring system 420 may be omitted and the first set of data sources 410 may be coupled directly to the mapping system 430. Mapping system 430 may also be coupled to a second set of data sources 415. The second set of data sources may include vulnerability and/or threat databases such as the Open Source Vulnerability Database. A data source may be any entity capable of generating or storing data. The mapping system 430 gathers data from all data sources, processes this data and creates estimates of selected parameters for subsequent modelling. Both “pull” and “push” data collection methods may be supported, i.e. the mapping system 430 may actively collect data from a data source (“pull”) or may receive data sent by a data source (“push”). Both data collection methods result in the mapping system 430 receiving data in some manner. These estimates may also be used without subsequent modelling, for example as stand-alone metrics. For example, the mapping system 430 may use the data from the data sources to estimate parameter values for probability distributions, such as any distributions that are used to model each of the processes in FIGS. 2 and 3. The term ‘security metric’ is used to refer to a final form of one or more estimated parameter values. For example, a security metric may comprise one or more of: the estimated parameter values for a probability distribution that is deemed a ‘best fit’ (e.g. highest confidence level or lowest error term); the estimated parameter values for a pre-selected security model; or a metric produced using one or more estimated parameter values, for example a metric that is produced based on experimental simulations or further mathematical manipulation, the experimental simulations being based on a mathematical or statistical model that uses one or more estimated parameter values.

In the example of FIG. 4A, estimated parameter values are output by the mapping system 430 either for use in modelling and simulation system 440 or for display on a dashboard 448. In the former case, the modelling and simulation system 440 accesses one or more security models, e.g. mathematical (e.g. statistical) representations of one or more processes relating to the security of a computing infrastructure, The security models may comprise, amongst others, one or more of: vulnerability threat management models, identity and access models, web access models, and security operations centre models. Any other form of security model may be used or created. A security model may feature process models similarly to the examples of FIGS. 2 and 3. A security model may be described using a structured programming language. For example, if a security model comprises a mathematical representation that uses a particular probability distribution, the mapping system 430 may be arranged to estimate values for the parameters for the distribution. Alternatively, certain implementations of the mapping system 430 may estimate the best-fitting probability distribution for a particular set of data received via interface 424 and/or additionally assessing the confidence levels for one or more fitted distributions. The modelling and simulation system 440 may use the estimated parameter values to run one or more simulations. Each simulation may involve random sampling from the modelled probability distributions, wherein the modelled probability distributions use the estimated parameter values output by the mapping system 430. The results of any simulations may be displayed, as illustrated by charts 444 and 446 in FIG. 4A. Likewise, estimated parameter values or security metrics generated based on such values may be displayed on the dashboard 448. A simulation may use one or more of the set of estimated parameters values and may vary other parameter values so as to explore “what-if” scenarios, for example those relating to the configuration of the computing infrastructure or the implications of making different assumptions in regard to external and internal model components.

FIG. 4B is a flow diagram illustrating an exemplary method for analysing a computing infrastructure. At step 450, data is received from one or more data sources. The data sources may comprise one or more of a security monitoring system for the computing infrastructure, a database identifying possible vulnerabilities and/or threats for the computing infrastructure, a security audit database for the computing infrastructure, and one or more log files for the computing infrastructure. A data source may also comprise a derived data source. At step 455, the received data is prepared for processing, i.e. is pre-processed. This may comprise one or more of buffering or recording the data over a time period, performing one or more operations using a database processing language and generating a derived data source based upon data stored in two or more other data sources. Following step 455, the data is in a state that is suitable for subsequent data processing, i.e. comprises prepared data. At step 460, an analysis of the prepared data is performed. The data processing may comprise statistical or numerical processing. The result of this step comprises one or more estimated parameter values, i.e. estimated values for parameters within a mathematical representation that forms part of a security model. This step may comprise one or more or fitting the prepared data to one or more mathematical representations, including deriving fitted parameter values for said one or more mathematical representations, determining confidence values for one or more fitted mathematical representations, comparing one or more estimated values of the parameters with equivalent stored values of the parameters and determining one or more statistical measures representative of the prepared data. Following step 460, the step of simulation may be performed. This may involve injecting, i.e. outputting, estimated parameter values to a modelling and simulation system that is able to use a security model comprising the mathematical representation associated with the parameters. Previous parameter values may be replaced with the newly estimated values. The step of simulation may be activated automatically and may comprise random sampling, e.g. Monte Carlo simulations, based on the mathematical representation and the estimated parameter values. Any experimental results from a simulation step may be output, together with any measures derived from step 460. This output may comprise a step of charting or generating a graphical representation, i.e. a visualisation step 470. The visualisation step 470 may follow one or more of steps 460 and 465, for example in the former case may output security metrics that result from the analysis performed in step 460. Results from steps 460 and/or 465 may be stored to support comparative analysis between estimated parameters and simulation outcomes, over user-defined periods of time. Trend analysis, comparisons across different computing infrastructures and/or organisations (“benchmarking”) and historical analysis may provide output for the visualisation step 470.

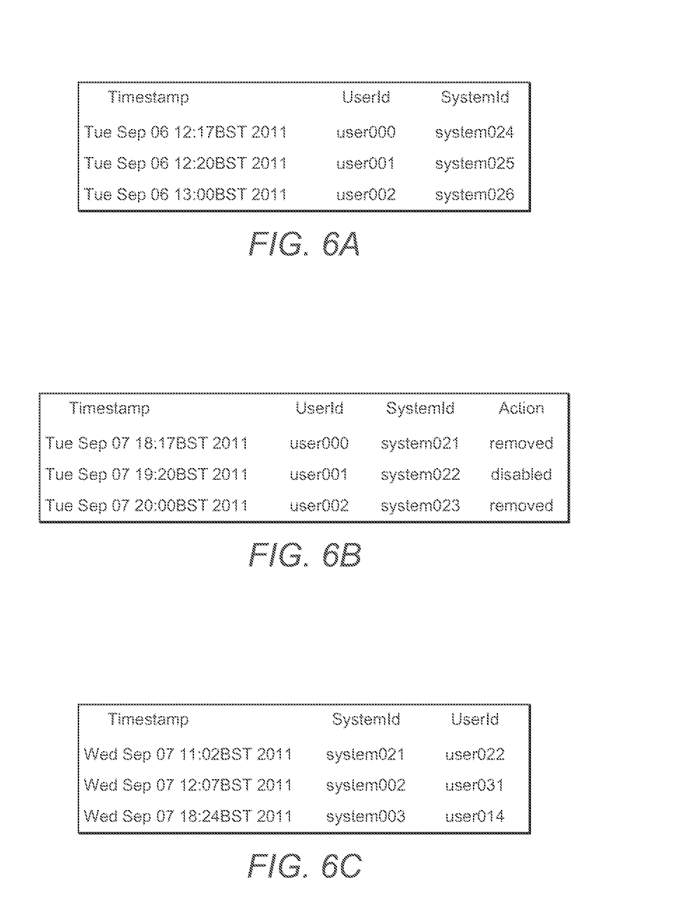

FIG. 5 is a schematic diagram of an exemplary implementation of the mapping system 430 as shown in FIG. 4. FIG. 5 shows a number of components that may be used in the exemplary implementation; however, in other implementations certain components shown in FIG. 5 may be omitted, certain components shown in FIG. 5 may be combined and/or additional components not shown in FIG. 5 may be added.

A first component of the mapping system is the parameter processing engine 510. The parameter processing engine 510 coordinates the collection of raw data from data sources. In the example of FIG. 5, the parameter processing engine 510 controls a number of modular plug-in processors 562, 564, 556. Each plug-in processor performs a defined set of pre-processing operations on data from one or more data sources 572, 574, 576, 578. These pre-processing operations produce pre-processed data that may be statistically analysed to provide estimates of various parameter values for selected models. The pre-processed data may also be referred to as prepared or historic data, the latter term representing the collection of the data over a time period in order to have enough samples to produce statistically meaningful results. The pre-processing may comprise one or more of: collecting or buffering an appropriate amount of data based on time periods specified in configuration information for a plug-in processor, for example using a data buffer or recording data to one or more databases; performing one or more operations using a database processing language, for example implementing SQL (Structured Query Language) commands; placing raw data in a standardised format that can be compared across differing system types and infrastructure configurations, for example normalisation operations; and generating derived data, for example by combining or performing queries on data stored in two or more data sources. The pre-processing performed by a particular plug-in module may be configured for a particular type of probability distribution or subsequent statistical processing. As described with regard to FIG. 4A, the data sources that provide data to the plug-in processors may comprise event and alert data sources or other suitable sources.

Following pre-processing, the parameter processing engine 510 performs data analysis of the pre-processed data based on available configuration information. The data analysis may comprise fitting the pre-processed data to a number of mathematical representations. The data analysis may involve, amongst others, one or more of data fitting, statistical analysis, numerical analysis. Data fitting may comprise curve fitting, e.g. constructing a curve or mathematical function that has the best fit to a number of data points provided by the pre-processed data. The data fitting may be subject to one or more constraints. Curve fitting may involve either interpolation, where an exact fit to the data is required, or smoothing, in which a “smoothing” function is constructed that approximately fits the pre-processed data. Numerical analysis applies algorithms that use numerical approximation. One or more statistical libraries may be used to perform the data analysis. For example, the pre-processed data may be analysed to determine, amongst others: if there are any frequency components; if the data is represented by one or more probability distributions, such as normal or Gaussian distributions, Bernoulli and binomial distributions. Pareto distributions, Poisson and exponential distributions; if the data is represented by one or more predefined lines, curves or multi-dimensional equations such as take-up curves; and if the pre-processed data displays any patterns such as clustering or discrete probabilities. If the pre-processed data does not match any library functions, e.g. if the confidence levels for each fit is below a predetermined threshold, a bespoke or composite function may be fitted to the pre-processed data. For example, a user or the mapping system may combine different curve equations until a confidence level exceeds a predetermined threshold. The result of this analysis is a range of estimated parameter values. A selected mathematical representation may also be output. Confidence levels for each determination or fit may also be provided. Estimated parameters may be stored in an estimated parameter database 516, such that the development and evolution of the estimated parameters over time may be analysed. In certain implementations, if pre-processed data cannot be fitted using smoothing algorithms, then an interpolation algorithm is applied. A range of interpolation methods may be used, for example depending on the data. These interpolation methods may include interpolation using Gaussian processes. Interpolation may be particularly important for certain security data, as there may not always be enough data to apply smoothing algorithms and accurate fit data with high confidence levels. Interpolation may also be applied where data fitting provides an erroneous result.

A number of components may be provided for the configuration of the mapping system. The mapping system of FIG. 5 comprises a configuration and management module 545. The configuration and management module 545 enables a configuration user 502 to configure the mapping system through a configuration interface 540, which may be a graphical user interface. The configuration and management module 545 enables the configuration user 502 to, amongst others, set up the mapping system for particular implementations and computing infrastructures, configure the mapping system in response to changes in the computing infrastructure or security analytic requirements, allocate particular security models to particular data sources and pre-processing, assign particular plug-in processors, configure statistical and/or mathematical models, and configure parameter descriptions and expected outcomes. Configuration information is stored in a configuration database 544, which may be a relational database.

In certain examples, the configuration and management module 545 enables a configuration user 502 to specify a security model to be used. A security model need not be associated with a particular modelling and simulation tool or system; it may be a chosen mathematical representation. hi certain configurations, a security model need not be selected; a mathematical representation may be selected based on the processing performed by the parameter processing engine 510. After selecting the security model, a list of parameters used by the security model may be displayed to the configuration user. The current values of each listed parameter may also be displayed. This may be implemented based on the parsing of a security model data the or via interaction (e.g. function calls) with a modelling and simulation system or tool. If a security model comprises multiple parameters, the configuration user is able to specify which parameters are to be estimated or re-estimated based on data collected from data sources. Finally, the configuration and management module 545 enables the configuration user to configure the way parameters are to be processed and how estimates are to be provided by the system. In certain implementations, the configuration user 502 may be distinguished from an end-user 504; for example, the end-user may be able to view outputs such as experimental results, security metrics and graphs, but may not be able to configure the mapping system; similarly a configuration user 502 may be able to configure the mapping system but not view outputs. In other implementations both users may have similar permissions.

FIG. 5 also shows a workflow manager 520. The workflow manager 520 co-ordinates system modules that use the results of the parameter processing engine 510. The workflow manager 520 may be responsive to interactions from users, such as configuration user 502 and operational user 504, and/or may control scheduled activities.

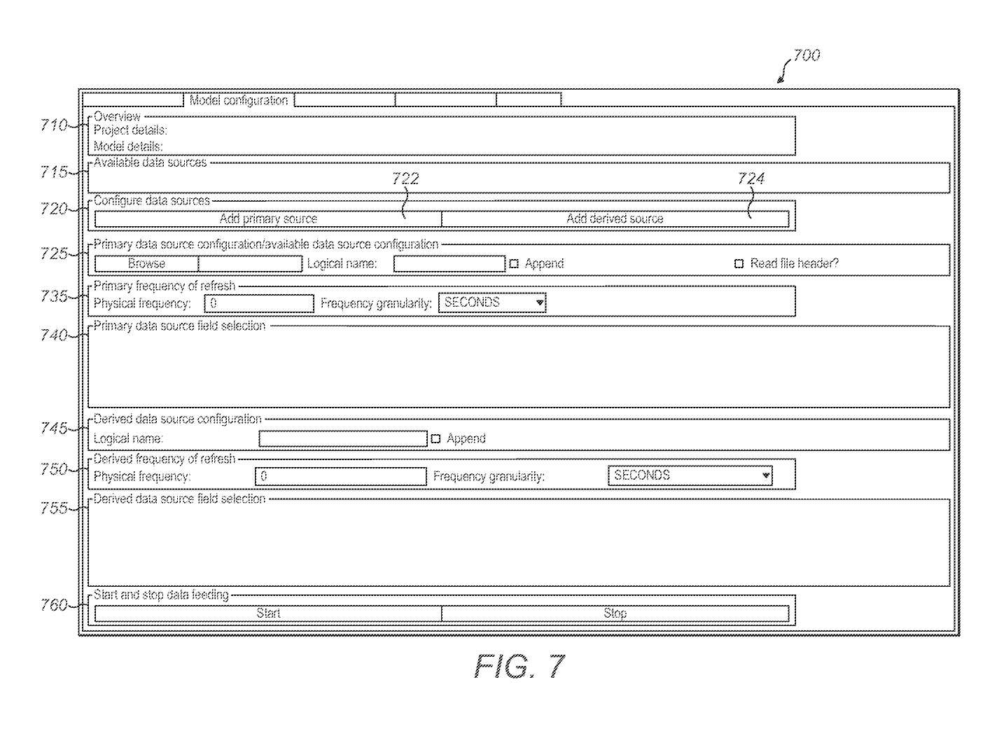

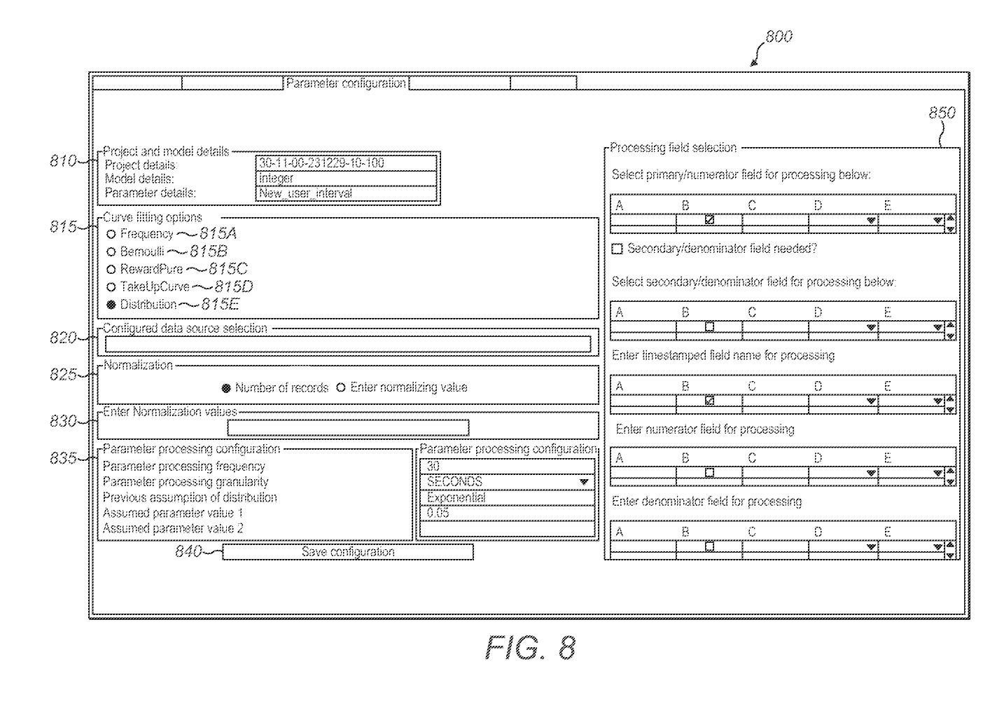

A first system module coordinated by the workflow manager 520 is parameter processing configuration module 511. This uses configuration information from the configuration and management module 545, for example that supplied by a configuration user 502 and/or configuration database 544, The parameter processing configuration module 511 configures the parameter processing engine 510 and/or one or more of the plug-in processors 562, 564, 556. It retrieves configuration information that specifies how to collect data from one or more data sources, such as event and alert data sources 572, 574 and 576 and other data sources 578, how to process this data, for example which plug-in modules are to be used, and how to estimate parameter values, for example which of one or more probability distributions to fit. Parameter processing configuration module 511 may control the pre-processing configurations defined using the exemplary first and second interfaces of FIGS. 7 and 8.

A second system module coordinated by the workflow manager 520 is confidence analysis module 512. In certain examples, this module determines a confidence level that is representative of the suitability of a particular mathematical model. For example, the confidence level may be calculated based on an error between prepared data and a fitted line or equation or based on a statistical deviation or other statistical measure. Certain smoothing algorithms may also generate a confidence level when applied to pre-processed data. In particular implementations, algorithms within this module graphically display estimated parameter values for selected mathematical representations, for example via dashboard interface 530 and display 532, and provide a classification based on calculated confidence levels. A classification scheme with two or more classifications may be used. The classifications may be based on threshold levels. For Example, on classification may be that the mathematical representation is “useable” or “unuseable”, a mathematical representation being useable if a calculated confidence level is above a particular threshold. Another classification may use a colour-coded system, for example a red, amber and green “traffic-light” colour scheme. The confidence analysis module 512 may present a user with a number of different mathematical representations and the confidence levels for data derived from a number of data sources; the user may then select a particular representation to define the security model and for use in a modelling and simulation system 440. The confidence analysis module 512 may be arranged to record the present selection, and any previous selections, in one or more of configuration database 544 and estimated parameter database 516.

A third system module coordinated by the workflow manager 520 is modelling and simulation mapping module 513. This module controls how parameter values estimated by the parameter processing engine 510 are mapped into existing modelling and simulation systems, for example modelling and simulation system 440. This module may make use of modelling and simulation interface 550 that provides a set of capabilities, such as function calls, application program interfaces (APIs) or data wrappers, to interact with existing modelling and simulation systems and tools 554, 556. For example, if a modelling and simulation system uses security models defined in a particular structured programming language, the modelling and simulation mapping module 513 may write estimated parameter values to configuration files for the security models, including placing the estimated parameters values in a format that can be read by the structured programming language and used be the modelling and simulation systems and tools. In certain implementations, modelling and simulation interface 550 outputs mapped parameters to particular modelling and simulation systems. These systems may provide a programming language and general framework to represent and run executable security models. They may also provide a framework to perform Monte Carlo simulations using the aforementioned security models.

A fourth system module coordinated by the workflow manager 520 is modelling and simulation simulation module 514. This module controls interactions between the mapping system and modelling and simulation systems. This may be achieved using modelling and simulation interface 550. For example, the modelling and simulation simulation module 514 may instruct a particular modelling and simulation system or tool 554, 556 to carry out an experimental simulation, using a selected security model and estimate parameter values from the parameter processing engine 510. In certain implementations, the modelling and simulation simulation module 514 uses the modelling and simulation mapping module 513 to place estimated parameter values in the correct form for simulation using a selected security model. A security model may be selected by an configuration user 502, for example using configuration and management module 545, or may be selected based on the suitability of security model following analysis, for example a security model that best fits measured and/or pre-processed data may be selected. In certain cases, if analysis shows that existing security models do not accurately model the data, a new security model may be generated based on a new or revised underlying mathematical representation. This new security model may then be used in the instructed simulation. The results of experimental simulations are stored in a results database 552.

A fifth system module coordinated by the workflow manager 520 is experimental outcome module 515. This module processes experimental results from simulations performed by one of more modelling and simulation systems or tools. The experimental outcome module 515 is arranged to retrieve experimental results stored in results database 552, in certain cases via modelling and simulation interface 550. The experimental outcome module 515 processes the experimental results so that, in one case, they can be displayed to an operational user 504 using display 532 and dashboard interface 530. This may involve processing the experimental results such that they can be graphical rendered, e.g. charted. It may also involve statistical summaries of the experimental results. Graphical rendering is performed by graphical rendering module 522. The graphical rendering module 522 is configurable and expandable based on the types of graphical results that might be required over time. For example, a “plug-in” or modular approach similar to that used for the plug-in processors 562, 564, 556 may be used. The graphical rendering module 522 and the display of experimental results in general, may be configured by a configuration user 502 via the configuration and management module 545.

Dashboard interface 530 provides an interface for the display of data to operational users. Operational users may be, amongst others, computer security professionals, members of a security operations centre, managers within the organisation associated with the computing infrastructure, business managers, governance managers, decision makers, risk assessors and other persons that are involved with the operation of the organisation. The dashboard interface 530 may provide a graphical framework, for example using a web-centric programming language or user interface libraries, to enable the display of information on display 532. This graphical framework may enable the modular display of the output of the graphical rendering module 522. it may also enable the output of a historical results module 526 to be displayed. Historical results module 526 enables display of historical simulation outcomes, for example previous experiment results from results database. This enables current estimated parameter values based on data sources 572 to 578 to be compared with parameter values estimated from simulations. These comparisons and historical results may be graphically displayed as output 536. Comparative analysis, possibly involving historical analysis, may be performed between a particular organisation and/or infrastructure and aggregated and/or anonymised data for a number of organisations and/or infrastructures. For example, this comparative analysis may be performed by a security operation centre that monitored a plurality of computing infrastructures for a plurality of organisations or customers. A result navigation module 524 enables operational users 504 to interact with displayed results, for example returning more detailed results when a user clicks on displayed data or switching between different graphs or chart types. In certain implementations, a user is able to define thresholds for the display of security metrics.

One advantage of examples described herein is that operational users 504 can review one or more of: security metrics based on historical ‘real-world’ data measured from the computing infrastructure; security metrics based on predictions developed using simulations; security metrics based on historical simulation data, e.g. previous predictions or results from simulations performed in the past; and security metrics based on different combinations of this data. A trends module 534 may be provided that displays how values of one or more security metrics vary with time (i.e. time-series data). The trends module 534 may be configured to use security metric values based on historical ‘real-world’ data for past values and security metric values based on simulations that use estimated parameter values for future values. For example, the security metric may be the percentage of computing devices in the computing infrastructure that have been patched after thirty days. Measurements from data sources may be used to calculate, this metric for past data, for example over the last six months. The same measurements may also be processed by the parameter processing engine 510 to determine estimated parameter values for a fitted take-up curve, e.g. to determine values for parameters in an probability distribution equation that defines a take-up curve. The estimate parameter values then may be using in simulations that repeatedly take random samples based on the probability distribution equation, for example Monte Carlo simulations. These simulations may then be used to estimate future values of the security metric, e.g. each day for the next six months may be taken as an independent trial. If values for certain parameters within a mathematical representation are varied, e.g. those relating to possible changes to the computing infrastructure, while other certain parameters have their estimated values, accurate “what-if” scenarios can be explored, with the predicted changes in security metric values displayed together with security metric values based on actual collected data from the past.

Further details of some of the functions of the mapping system will now be described, with reference to a number of examples,

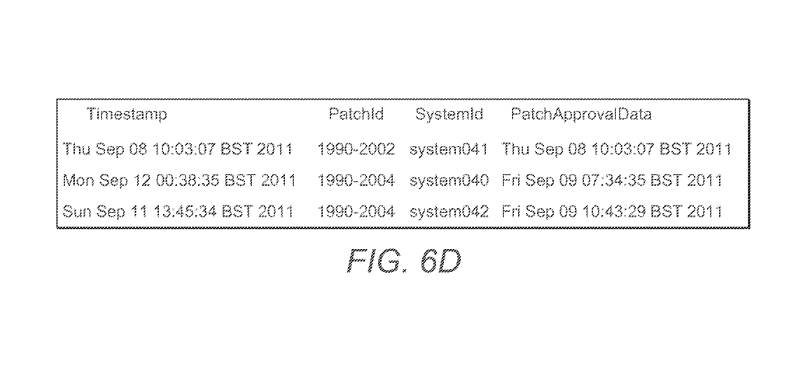

FIGS. 6A to 6D show data from four exemplary data sources. These Figures are provided as examples of data that may be generated within one particular implementation; they are not to be seen as limiting on other examples or implementations. Even though the examples show the data in the form of database tables, other data forms, such as data objects, may also be alternatively used depending on the implementation. The data may be generated by an event and alert monitoring system 420. For example, a computing infrastructure for an organisation may comprise a number of computing workstations, a number of servers under the control of a server operating system (such as Windows Server® by Microsoft Corporation of Redmond, Wash.) devices, a directory service (such as Microsoft's Active Directory) and a computing event manager (such as Microsoft Event Manager). An event and alert monitoring system or plug-in processor may be arranged to access these components of the computing infrastructure, and/or any data files or databases created by these components, and produce periodic reports. These periodic reports may comprise one of the data sources illustrated in FIGS. 4 and 5.

FIG. 6A shows data representing users that joined an organisation and obtained user accounts on specific computing devices. It has three fields: Timestamp, UserId and SystemId. Each now of data records the date and time (“Timestamp”) that a user with the user identifier “UserId” obtained a user account on a computing device with the system identifier “SystemId”. The data shown in FIG. 6A may be measured as metrics 225 from FIG. 2.

FIG. 6B shows data representing users that left an organisation and/or changed roles and as such lost access to user accounts. The data shares the three fields of FIG. 6A and has an additional field—“Action” that provides further information on the change in user status. For example, the first and third users have been respectively removed from computing devices “system021” and “system023”, while the second user has been disabled with regard to computing device “system022”. The data shown in FIG. 6B may be measured as metrics 270 from FIG. 2.

FIG. 6C shows data representing successful logins to user accounts related to people that have left an organisation or changed role, e.g. relating to user accounts that have expired and that should have been deprovisioned. Each entry in the data represents the data and time (“Timestamp”) that an expired user (“UserId”) logged into a particular computing device (“SystemId”).

FIG. 6D shows data representing successfully patched computing devices, i.e. computing devices that have successfully installed a particular software update. Each entry has a “Timestamp” value indicating the date and time that a patch was applied. The field “PatchId” indicates the particular patch and the field “SystemId” indicates the computing device the patch was applied to. Finally, the field “PatchApprovalData” indicates the date and time that a patch was approved, for example the time a computer security engineer agreed that all computing devices within the computing infrastructure should have the patch applied. This last field enables the time between a patch being approved and applied to be calculated. This time may comprise the pre-processed data upon which the parameter processing engine 510 operates in one example.

The data shown in FIGS. 6A to 6D may be collated using data from Active Directory, security event logs and local system logs. Additional databases may also be used, such as human resources data files that indicate an employee change for the data of FIG. 6C. The data sources that provide the data shown in FIGS. 6A to 6D may be used to determine estimated parameter values for identity and access management and vulnerability and threat management security models. These models assess security risks derived, respectively, from the processes that handle user accounts and the patching of computing devices. For example, using the Exemplary implementation shown in FIG. 5, a configuration user can configure the mapping system so that the aforementioned exemplary data sources are mapped to the aforementioned security models. This may be achieved using the configuration and management module 545. If necessary, particular parameters within each security model may be selected or an automated module may extract a list of parameters used in a security model by parsing one or more structured data files associated with the model. In certain configurations, current parameter values, for example as defined in security model data files before estimation, may be extracted. This previous parameter values may be stored together with historic estimates in the estimated parameter database 516. In the context of FIGS. 6A to 6D, examples of parameters that may be selected and/or extracted comprise: parameters defining a take-up curve for patching systems in an organisation in a given timeframe; and parameters indicating the number of misused accounts in a given timeframe, e.g. the number of “hanging” accounts that have been used yet relate to people that left an organisation and/or changed roles.

A number of exemplary user interfaces will now be described so as to illustrate some of the functions of the mapping system. These user interfaces may comprise, for example, one possible implementation of the configuration interface 540 to enable a user to configure the parameter processing engine 510, plug-in processors 562, 564 and 556, and data sources 572 to 578 by way of the configuration and management module 545 and parameter processing configuration module 511. These exemplary user interfaces are provided to facilitate explanation of certain features of certain examples; they are not to be seen as limiting. Implementations may use different user interfaces and these may offer configuration and display options that differ from those shown in these examples. Furthermore, any applied graphical user interface may be changed or developed with successive versions of an implementation. They may or may not be used with the previously described examples of FIGS. 4A, 4B and 5. Additionally, it should be understood that in other implementations a graphical user interface may not be required; for example, the configuration of the parameter processing engine 510 may be achieved using a text-based command line interface or input data streams that are independent of components 542, 540 or 545.

FIG. 7 shows a first exemplary interface 700 for configuring data sources according to an exemplary implementation. In this implementation, there may be a number of configurations each defined as “projects”. Overview panel 710 provides details of the presently-selected project and security model. There may be an option to change the presently-selected project and security model. The security model may be selected from a library of security models or through the parsing of a modelling and simulation file. Available data sources panel 715 enables navigation between different data sources.

In this example, data sources may be one of two types: primary data sources and derived data sources. Primary data sources are sources of raw data directly provided from the computing infrastructure or by external systems, such as monitoring systems, audit applications, threat management applications and external databases. Examples of primary data source comprise: a list of patched systems in a given time period along with the patch identifiers; and a list of people joining or leaving an organisation in a given time period along with the user identifiers. Derived data sources are sources of intermediate data obtained by processing data contained in raw data sources and/or other derived data sources. Derived data sources are distinguished from data generated by SIEM solutions in that derived data sources provide data that is processed to provide relevant data sets that support data analysis such as statistical assessment. For example, a derived data source may correlate a list of patched systems and their patch times with an approval date to deploy a patch and additional information about the patch, such as data defined by one or more Common Vulnerability Scoring System (CVSS) databases. The data shown in FIG. 6D may be generated from a derived data source. Another derived data source may correlate human resources data identifying personnel that have left an organisation with information about their user accounts and any unauthorised usage. The data shown in FIG. 6C may be generated from a derived data source. Derived data sources may be defined using a configuration interface, such as 540 in FIG. 5, or using external data management software. Derived data sources may be defined iteratively, for example by correlating two or more primary and/or derived data sources. The generation of a derived data source may comprise a step of the data pre-processing described above.

Data sources may be added using data source configuration panel 720. For example, a primary data source may be added to the configuration using control 722 and a derived data source may be added to the configuration using control 724. Once a data source has been added it is shown as being available in available data sources panel 715. Panels 725, 735 and 740 and panels 745, 750 and 755 respectively enable further configuration of a selected primary and derived data source. Panels 725 and 745 allow for configuration of a selected data source, for example the selection of a physical or logical database, whether data should be appended to an existing data source, whether a the header shown be read etc. Panels 735 and 750 allow for configuration of the sampling frequency of a data source, for example whether data is taken from the data source every n seconds, minutes, hours etc. In the present example, the original data source is not modified, as the data source may be required for the successful operation of the computing infrastructure. Hence, data from a data source is sampled and stored in a buffer file or table. This buffer file or table further allows for the aggregation of data over a pre-determined time period. in certain implementations the data collected from both raw and derived data sources is stored in a SQL database, with tables automatically created and managed by the mapping system. Specifically, in this case, the manipulation of data sources and the definition of “derived data sources” are managed by means of explicit, annotated SQL queries. Programming scripts and/or graphical programming approaches may also be used in a similar manner. For example, visual programming that uses “query by example” may be used, wherein a user graphically selects suitable data. Panels 740 and 755 enable a subset of available fields from a data source to be selected. For a derived data source, panel 755 also allows for correlations between different data sources to be configured. The mapping system manages the synchronisation between raw data sources and derived data sources using dependency relationships. A data feed control panel 760 is also provided to start and stop the feeding of data from the configured data sources.

As illustrated by the example of FIG. 7, certain examples enable configuration of data sources including basic data processing, filtering and cleaning capabilities to generate prepared data. Often only part of the information required for parameter estimation is directly available from data sources. Hence, certain examples allow data sources to be defined and combined, in a flexible and programmable way. For example, data fields from two or more raw data sources may be correlated in a derived data source to provide the information required for parameter estimation. The final data set that is collected and stored for subsequent parameter processing, following the configuration of one or more data sources, is referred to as prepared data, i.e. data collected over time that is to be used to estimate a parameter.

FIG. 8 is an illustrative screen shot of a second exemplary interface 800 for configuring the processing of data, in particular for configuring parameters within a selected security model. Similar configuration options may also be provided for parameter values that are estimated independently of a selected security model, e.g. for parameter value estimations that are associated with stand-alone security metrics. Following the association of data sources to a particular security model, and the configuration of the associated data sources, the second interface allows a user to define which parameters in the selected security model are to be estimated and how this is to be achieved. This configuration step drives the subsequent parameter estimation process.

First a parameter is selected. Project and model details are displayed in panel 810. In certain implementations, a control is provided that lists all parameters for the selected security model. This list may be provided by parsing a structured language file that defines the security model as described above. In other implementations no project may be selected; for example, a list of stand-alone security metrics to estimate may be provided, these metrics relating to a particular organisation or being common to multiple organisations. Once a parameter is selected, a user specifies its assumed parameter type. In the example of FIG. 8, a list of supported parameter types include: frequencies 815A; Bernoulli distributions 815B; reward functions 815C; take-up curves 815D; and generic probability distributions 815E. Panel 815 may display an expected parameter type based on an initial analysis of the configured data sources. Data from one or more configured data sources to be used for the parameter estimation is selected using panel 820. Normalisation panels 825 and 830 offer a number of normalisation options for the data. Parameter processing configuration panel 835 allows a user to configure the processing of the data from the data sources. For example, FIG. 8 provides options for adjusting the sampling frequency for pre-processed data when generating estimates of parameter values. Different levels of granularity for a sampling frequency may also be selected; for example seconds, minutes or hours for time data. A previous assumption for a parameter type or distribution may be provided, or entered by a user, together with previously assumed parameter values. For example, these previous assumptions may be identified following a parse of a security model structured data file. Depending on the type of parameter, additional contextual information might need to be provided. For example, in case of reward functions and take-up curves, a user specifies the number of points to be extracted from the collected data that is required to interpolate the distribution. Field selection panel 850 allows data fields containing prepared data to be selected for processing. These fields may comprise, for example, fields in an SQL database as described above. Control 840 offers the user the opportunity to save a configuration. A control to start processing may also be provided.

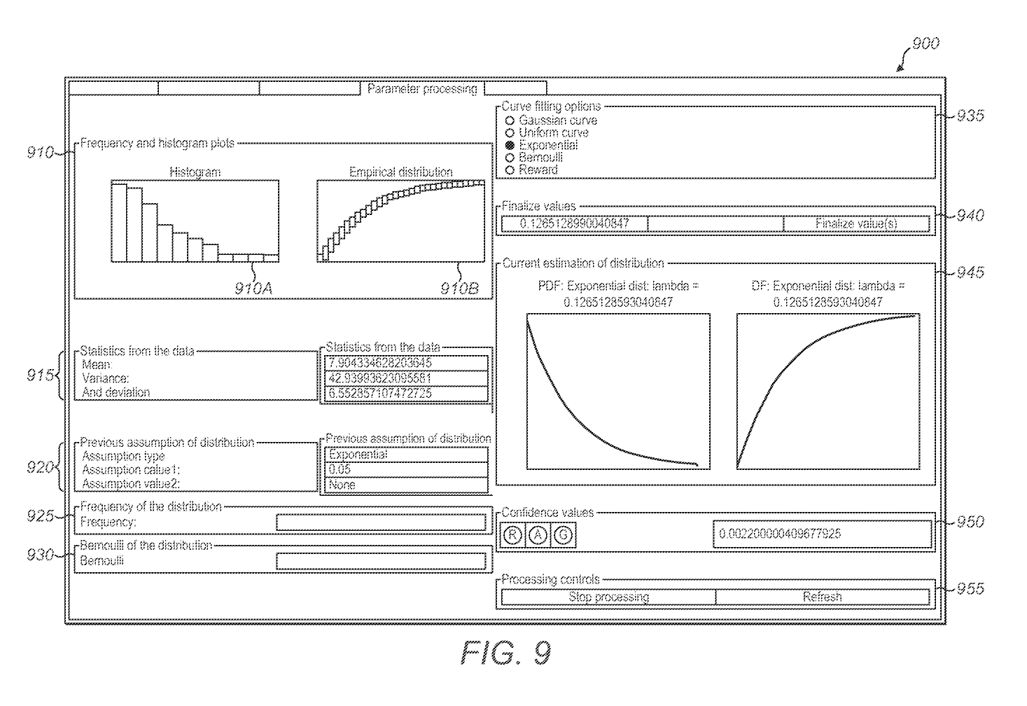

FIG. 9 is an illustrative screen shot of a third exemplary interface 900 that displays the result of processing the prepared data. As discussed previously. FIG. 9 is provided to facilitate an explanation of certain features of certain implementations and should not be taken as representative of the full functionally of components such as dashboard interface 530. In the illustrated example, the parameter to be estimated is the interval between successive new user registrations. A data source for this parameter representation may provide data similar to that shown in FIG. 6A. In this case, the parameter processing may be configured such that the time interval between entries in data from the data source is used as the prepared data; for example, in FIG. 6A a first time interval value is 3 minutes and a second time interval value is 40 minutes.

Panel 910 in FIG. 9 shows histogram 910A and empirical cumulative distribution function 910B plots for the prepared data. The histogram may be based on bins for the data set during configuration. These plots illustrate the nature of the collected data, its distribution and potential issues, e.g. lack of data or the likelihood of multimodal or exotic distributions. There is also the option to compare the plots with previous generated versions, for example the present parameter processing may use collected data for the last six months and previous processing may have used collected data that is between twelve and six months old. Other individual curve plots based on the prepared data may also be generated on demand. Statistics calculated from the prepared data are also shown in panel 915. The statistics shown in FIG. 9 include the mean, variance and standard deviation of the interval period. Panel 920 shows the previously assumed values for the data, in the shown example the data was assumed to be represented by an exponential distribution with a lambda or rate parameter of 0.05. This enables a user to compare the current estimate against values previously defined in a security model and spot potential inconsistencies. Panels 925 and 930 respectively display frequency and Bernoulli parameter estimates if they are relevant to the parameter processing configuration. Panel 935 enables a user to view and/or change the type of mathematical representation that is fitted to the data, for example in the present case allowing the fit of a Gaussian curve, a uniform curve, an exponential curve, a Bernoulli function or a reward function. Panel 935 may display a selection of best fitting mathematical representations following analysis of the data. For example, the five options shown in FIG. 9 may be five mathematical representations with the highest confidence levels. Panel 940 shows the finalised estimated parameter values. In the illustrated example, a mathematical representation comprising an exponential probability distribution is selected to represent the data. From fitting an exponential curve to the data, lambda or the rate parameter for such a mathematical representation is estimated to be 0.127 (to three decimal places). Panel 945 shows probability density functions and cumulative distribution functions plotted using the estimated parameter values. Other mathematical representations may have one or more estimated parameter values; for example a Gaussian distribution may be defined by mean and variance parameters.

The exemplary implementation of FIG. 9 also provides an analysis of how the collected data fits various predefined mathematical representations, such as probability distributions or plotted curves, along with an indication of the level of confidence. Confidence levels may be calculated using standard statistical libraries, for example based on a fitted curve. Panel 950 shows a confidence value for the estimated parameter together with red, amber and green (‘R’, ‘A’, ‘G’) indicators. One of the indicators will be illuminated upon the display based on the confidence value. For example, thresholds for the confidence value may be associated with each indicator. In certain examples, a number of mathematical representations may be fitted to the prepared data and the mapping system automatically identifies the best fitting mathematical representation, if there is one, based on the confidence value. There is also the option for a user to experiment with different mathematical representations including: exploring alternative fitting options; building their own curve by selecting multiple (x, y) points; and adding extra data points. For example, a configuration user may graphically draw a curve for the data, or alter a curve suggested by statistical or numerical analysis based on predefined functions if it is deemed not suitable.

The interface of FIG. 9 also provides a control 955 that stops processing, for example after starting processing using one of controls from the configuration stages, and a control to refresh estimate parameter values, for example based on data that may have been collected after a last set of processing.

As seen in FIG. 9, certain examples collect data from a computing infrastructure, pre-process that data according to defined configurations then attempt to fit the data to a mathematical representation. Threaded processes may be used to handle the processing of data and support statistical analysis. The mathematical representation, together with estimated parameter values derived from fitting the data, then form the basis for a security model that is representative of security processes for a computing infrastructure. If the estimated parameter values themselves provide useful information they may be output as security metrics for a computing architecture. For example, a security model may represent the time of day unauthorised log-ins are most likely to occur, which may be a multimodal Gaussian distribution. In this case, one set of parameter values comprise the peak locations for the Gaussian distribution and these may be output as security metrics representing the most likely times of unauthorised log-ins.

Following parameter estimation, certain examples of the mapping system enable a user to determine how to use estimated parameter values. In one implementation a user is provided with the option to use the new estimated parameter values by injecting them into a predefined security model used by a modelling and simulation system, replacing any previous assumptions of the parameter values. For example, the mapping system may be used to replace previously assumed values in the security models described with regard to FIGS. 1 to 3. When the user is given this option they may decide, for example from the results illustrated in the interface of FIG. 9, not to inject the estimated parameter values. This may be the case if the confidence values are classified as red or amber in the “traffic light” indicators or if the results indicate that there may be issues with the form of the collected data. If the user selects the option to insert the estimated parameter values, the mapping system automatically sets the parameter to the chosen value, within the security model. This may be achieved by writing parameter values into data files used by the modelling and simulation system that define a particular security model. Similar processes may be applied to other parameters handled by the system.

Further defined interfaces may also enable a user to configure the translation of estimated parameter values to a format or notation suitable for use in one or more security models. In general, the mapping system allows a user to have full control of the overall process. The level of interaction required from a user may vary according to the implementation: in some implementations a user may decide to configure and supervise the entire parameter estimation process, for example in an iterative manner; in other implementations the parameter estimation process may be automated, with a user setting initial configuration information. Any combination of the two approaches may be applied. In an automated case, parameter estimation may be regularly scheduled, for example to calculate new parameters based on new collected data every month, quarter or year. The mapping system may be configured such that parameter values within a security model are only automatically replaced based on a threshold comparison of the calculated confidence level. Automated reports for operational users that present security metrics based on estimated parameter values may also be regularly scheduled as an output phase of regular parameter processing.

Once parameter estimates are inserted or injected within a security model for a modelling and simulation system or tool, either the user or the mapping system can start a simulation step. The modelling and simulation system may form part of the mapping system or may be separate. The simulation step may be based on predefined sampling frequencies as defined in configuration information. In one implementation, the modelling and simulation system uses the underlying mathematical representation to carry out Monte Carlo trials. In this case, the experimental outcome of these trials may be processed and displayed to a user based on predefined graphical templates. Specifically, the mapping system interfaces with these systems or tools to start the simulation activity, for example via a function call or API. In the implementation of FIG. 5, the mapping system wafts for the simulation to finish, retrieves the simulation results and stores them within a local database. The mapping system is then able, at a later time, to process the stored experimental data and generates graphs of relevance for security risk assessment and managerial decision support.

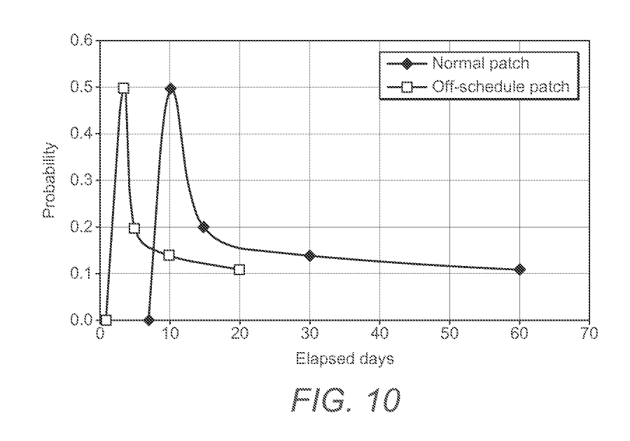

FIG. 10 shows an example of a mathematical representation in the form of a probability distribution of the patch take-up curve. This representation may form the basis of a security model. In particular, FIG. 10 shows two take-up curves. A first take-up curve shows the probability of a particular computing device being patched (i.e. that a software patch has been installed) with a normal patch after a particular number of elapsed days. The number of days may relate to the time that has elapsed following a decision to approve the installation of a patch or following a patch being made available. The probability of a particular computing device being patched may also be interpreted as the proportion of computing devices within a computing infrastructure that are likely to be patched at a particular time period, e.g. half of the computing devices are likely to be patched on a day 10 days later. FIG. 10 also shows a similar take-up curve for an off-schedule patch, i.e. a patch that does not follow a normal release schedule by a software publisher. An off-schedule patch may relate to an emergency security fix. In this latter case the patch is applied more rapidly, with the peak of the take-up curve occurring earlier. FIG. 10 thus demonstrates how one particular security model, i.e. that relating to the modelling of software patch management on computing devices within the infrastructure, can use the outcome of data analysis. In one case, a curve can be used directly; for example, a number of data points on the curve may be used in a security model by the modelling system. In another case, an equation may be used, such a polynomial equation. In another case, statistical parameters that define the data may be used in the security model, such as the mean or median. For example, the take-up curve of FIG. 10 may be represented as set of data points derived from data interpolation using Gaussian process. A user may not directly view an equation, for example in some cases the exact mathematical representation may be determined based on statistical and/or numerical methods and may be hidden from a user. The equation parameters are the parameters that are estimated from data collected from a computing architecture. For example, the data of FIG. 6D could be correlated with patch details (eq. based on the “PatchId” field) that specify whether the patch is a “normal” or “off schedule” patch. The result of the correlation is a derived data source. A user may then configure parameter estimation such that the difference between the “PatchApprovalDate” field and the “Timestamp” field, for each of labelled “normal” or “off schedule” patches, for the last three months comprises prepared data for use in parameter estimation. The statistical analysis methods are then applied on this prepared data for each of the two cases, using a Gaussian interpolation method for example, to derive estimated parameter values for the curves shown in FIG. 10. A security metric may then be derived from the estimated parameter values for the curves, for example the area under each curve may be integrated to derive the proportion of computing devices that would be patched by a certain number of elapsed days. Alternatively, if they are understood by a user, the estimated parameter values themselves may comprise the security metrics. In the present case, an exemplary simulation may combine the patch uptake curve with external threat environment parameters such as vulnerability exploit arrival rate and patch release rate by vendor to derive a risk exposure window across the infrastructure of devices where patches are applied. As the system uses collected data, such an analysis can be performed at any time, and may relate to any historic or future time period, and different periods of time may be compared. This allows operational managers of a computing infrastructure to accurately understand security risks and the effects of various infrastructure changes based on constantly updated objective data.

In summary, the described examples relate to the management of a computing infrastructure. In particular, but not exclusively, the examples relate to the generation of security metrics for use in management of the computing infrastructure, the generation of the security metrics being based on security data derived from the computing infrastructure.

Certain examples solve a problem of how to improve risk assessment and support for decisions associated with the security of a computing infrastructure within organisations. To be effective, this risk assessment needs to factor in one or more of organisation processes, people behaviours, critical systems and business solutions. In the past, security risk assessment and decision support has been considered separately from the day-to-day management and control of the computing architecture. This has lead to a knowledge “gap”, i.e. high-level decisions concerning the structure and configuration of a computing infrastructure, for example whether to use this or that system or whether to restrict the coupling of person mobile devices to an organisations networks, are made without considering an actual or predicted behaviour of the computing infrastructure based on data recorded from the computing infrastructure itself. It is also difficult to convey information regarding security threats to strategic personnel, for example, information based on day-to-day computing infrastructure operations. There is also a lack of consistency regarding language and measurements. For example, risk assessment activities to identify threats and mitigate them with suitable policies and controls have been, in the past, business-driven and made on an ad-hoc basis by outside consultants or based on an audit when something goes wrong. This is very expensive, complex to achieve and at best only provides an untraceable snapshot of the operation a computing infrastructure. On the other hand, organisations typically invest in monitoring and security information and event management (SEM) solutions to collect large amount of information from their computing infrastructure, for compliance and governance purposes. However, these SEM solutions are driven by day-to-day, low-level, i.e. via a bottom-up approach driven by computing objectives; they are not used for high-level decision making in relation to the computing infrastructure.

Certain examples address this problem by introducing a mapping system that makes use of information collected from various data sources, including SEM solutions and threat management systems. Following appropriate pre-processing, the mapping system analyses this information to provide estimated values for parameters in a security model, the security model in turn being based on one or more mathematical representations. In certain cases, the security model may comprise a mathematical representation or probability model, in other cases the security model may be complex, i.e. model multiple sub-process and be generated by a modelling and simulation system. In certain implementations, the mapping system also transforms the estimated parameter values for use in a security model that forms part of a modelling and simulation system or tool, for example overwrites previously assumed parameter values in data files used by external modelling and simulation software. Any security model with update parameters based on the estimated parameter values may be used to generate security metrics that can inform decisions concerning the security of the computing architecture, for example in security risk assessment and decision support at the business and technical security level.

Hence, certain examples have an advantage of providing a technical system and method to bridge the gap existing between higher-level risk assessment, e.g. relating to system-wide properties of a computing infrastructure and specified user behaviour, and lower-level governance and compliance, e.g. based on logging and monitoring systems.

Certain examples also address the problem of accommodating the variations in organisations and security threats when implementing a security solution. Certain examples address this problem by providing objective measurements of the nature of a computing infrastructure that can inform decisions and prevent ill-advised choices and configurations. Simulations can use estimated parameter values based on actual collected data to ensure accuracy and relevance. This also avoids potential errors that may be introduced using other approaches, for example where data is collected manually by experts or consultants based on interviews and the like.

There is also an advantage of supporting an ongoing assessment of security risks and computing infrastructure operation. For example, information can be continuously collected from raw or derived data sources, allowing parameter values to be estimated for any time period from a current time. This can be contrasted with approaches that require manual ad-hoc recording for a specified time period or SEM solutions that provide real-time alerts but do not record information that may be used to determine longer-term historic trends and patterns. The approach of the described examples also factors in changes to the computing infrastructure. This may not be the case with one-off audits or reports. For example, if a number of computer workstations are added to a computing infrastructure this will be incorporated into the collected data and hence into estimated parameter values. However, assumed parameters derived from a one-off analysis of real-time data six months previously may be used for the expanded system without thought, giving a skewed insight into operation that can lead to business and technical problems.

Another advantage is that security metrics and/or estimated parameter values for any number of specified time periods can be compared. For example, by providing an indication of how security metrics and/or estimated parameter values change over time, users can see how the behaviour of a computing infrastructure evolves over time. Security metrics for different users, systems, computing infrastructures and organisations may also be compared using benchmarking functionality. It also enables users within an organisation to identify trends of relevance for security risk assessment and decision support. Through the inclusion of simulation results, time-series data may illustrate historic and predicted security metric values, allowing a complete view of trends and enabling users to identify potential problems.

Another advantage is that security metrics can be linked to the actual collected data, for example for auditing or reference purposes. For example, if an operational user clicks on a displayed security metric or chart, they may have the option to view the estimated parameter values, pre-processed data and/or raw data the metric is based on. The configuration information for the mapping system may comprise a relational database that associates the various data records and metrics.

The mapping system also has an advantage of being suitable for provision as a software service. Through the mapping systems modular approach it may receive data from a remote computing infrastructure and/or inject estimated parameters values into remote security analytic tools. For example, the mapping system may be implemented on a server remote from an organisations computing infrastructure, whereas SIEM solutions and/or security analytic tools may be operated by a security operations centre within the organisation. In implementations where the mapping system has access to estimated parameter data for multiple organisations, it may be arranged to output a score for a particular organisation in relation to other ones of the multiple organisations. For example, if all organisations use a common security model then the estimated parameter values, or security metrics generated based on said estimated parameter values, may be compared. Anonymised data may be used to respect the privacy of each organisation.

The above examples are to be understood as illustrative examples of the invention. Further examples of the invention are envisaged and certain variations have been discussed in the description above. it is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A system for analysing a computing infrastructure, comprising:
at least one data pre-processing module to receive security data from one or more data sources over a time period and to pre-process said security data, the security data comprising at least data relating to the operation of the computing infrastructure; and
a parameter processing engine to perform data analysis on pre-processed data from the at least one data pre-processing module and determine, based on the data analysis, values for one or more parameters of a security model, the security model comprising at least a mathematical representation of a process relating to security of the computing infrastructure.

2. The system of claim 1, wherein the at least one data pre-processing module comprises at least one of:
a data buffer to buffer the security data over the time period;
a command processor to perform one or more operations using a data processing language; and
a derived data source generator to generate pre-processed data based upon security data received from two or more data sources.

3. The system of claim 1, wherein the one or more data sources comprise one or more of:
a security monitoring system for the computing infrastructure;
a database identifying at least one of possible vulnerabilities, possible threats, or a combination thereof for the computing infrastructure;
a security audit database for the computing infrastructure; and
one or more log files for the computing infrastructure.

4. The system of claim 1 wherein the parameter processing engine comprises one or more of:
a data processor to fit the pre-processed data to one or more mathematical representations, including deriving fitted parameter values for said one or more mathematical representations;
a confidence processor to determine confidence values for one or more mathematical representations fitted by the data processor;
a comparator to compare one or more determined values of the parameters with equivalent stored values of the parameters; and
a data analyser to determine one or more statistical measures representative of the pre-processed data.

5. The system of claim 1, wherein the parameter processing engine comprises a data processor to determine a mathematical representation that best fits the pre-processed data, said mathematical representation being selected as the mathematical representation for the process relating to the security of the computing infrastructure.

6. The system of claim 1, comprising:
a simulator to perform one or more simulations using the security model and the values of the one or more parameters so as to generate predicted security metric values.

7. The system of claim 6, comprising:
a display interface to output time-series data for one or more security metrics based on the results of the simulator and the parameter processing engine, the time-series data comprising one or more of past and future time values.

8. The system of claim 1, comprising:
a graphical user interface to display a graphical representation of one or more security' metrics, the one or more security metrics being generated based on the determined values for the one or more parameters of the security model.

9. The system of claim 1, wherein the mathematical representation comprises at least one discrete-event process model, discrete events being modelled using one or more probability distributions, the one or more parameters comprising parameters within said probability distributions.

10. The system of claim 1, comprising:
a parameter injector to write the values of the one or more parameters determined by the parameter processing engine to a data file.

11. The system of claim 10, wherein the parameter injector replaces one or more previous values of said one or more parameters in the data file.

12. A method of analysing a computing infrastructure, the method comprising:
receiving security data from one or more data sources over a time period, the security data comprising at least data relating to the operation of the computing infrastructure;
pre-processing the security data to produce pre-processed data; and
performing data analysis of said pre-processed data to determine values for one or more parameters of a security model, the security model comprising at least a mathematical representation of a process relating to security of a computing infrastructure.

13. The method of claim 12, wherein the step of pre-processing the security data comprises at least one of:
buffering the security data over the time period;
performing one or more operations using a data processing language; and
generating pre-processed data based upon security data received from two or more data sources.

14. The method of claim 12, wherein the data sources comprise one or more of:
a security monitoring system for the computing infrastructure;
a database identifying at least one of possible vulnerabilities, possible threats, or a combination thereof for the computing infrastructure
a security audit database for the computing infrastructure; and
one or more log files for the computing infrastructure,

15. The method of claim 12, wherein performing data analysis of said pre-processed data comprises one or more of:
fitting the pre-processed data to one or more mathematical representations, including deriving fitted parameter values for said one or more mathematical representations;
determining confidence values for one or more mathematical representations fitted to the pre-processed data;
comparing one or more determined values of the parameters with equivalent stored values of the parameters; and
determining one or more statistical measures representative of the pre-processed data.

16. The method of claim 12, wherein the step of performing data analysis comprises:
determining a mathematical representation that best fits the pre-processed data, said mathematical representation being selected as the mathematical representation for the process relating to the security of the computing infrastructure,

17. The method of claim 12, comprising:
performing one or more simulations using the security and the values of the one or more parameters so as to generate predicted security metric values,

18. The method of claim 17, comprising:
using the results of the one or more simulations and the results of the data analysis to output time-series data for one or more security metrics, the time-series data comprising one or more of past and future time values.

19. The method of claim 12, comprising:
generating a security metric using the determined values for the one or more parameters; and
comparing the security metric with one or more other security metrics generated based on data for other computing infrastructures.

20. The method of claim 12, wherein the mathematical representation comprises at least one discrete-event process model, discrete events being modelled using one or more probability distributions, the one or more parameters comprising parameters within the probability distributions.
